(19) United States
(12) Patent Application Publication
(10) Pub. No.: US 2005/0144586 A1
(43) Pub. Date: Jun. 30, 2005

(54) Automated generation method of hardware/software interface for SIP development

(75) Inventors: Jia-Horng Shieh, Taipei City (TW); Allen Lin, Taipei City (TW); Chi-Yang Hu, Taipei City (TW); Tse-Min Chen, Taipei City (TW); Li-Chun Ko, Taipei City (TW); Yen-Ting Chen, Taipei City (TW)

Correspondence Address: BACON & THOMAS, PLLC, 625 SLATERS LANE, FOURTH FLOOR, ALEXANDRIA, VA, 22314, US

(73) Assignee: Institute For Information Industry, Taipei City (TW)

(21) Appl. No.: 10/878,322

(22) Filed: Jun. 29, 2004

(30) Foreign Application Priority Data
Dec. 24, 2003 (TW) 092136738

(51) Int. Cl. G06F 9/44

(52) U.S. Cl. 717/100

(57) ABSTRACT

An automated generation method of hardware/software interface for SIP development is provided. The method comprises establishing a template wherein an interface template is established for enabling a user to quickly generate a system architecture, designing a hardware access program wherein a driver is provided for a model of the interface template so that a user is able to run the driver to verify the correctness of a designed IP, designing a driver for creating a driver complying with a driver of an OS, and repeatedly verifying a created design module and a management module so as to determine the correctness of codes created by an interface module.

### BACKGROUND OF THE INVENTION

1. Field of the Invention

The present invention generally relates an automated generation method of hardware/software interface for SIP development.

2. Description of Related Art

Current embedded system design has entered into a single on-chip (SOC) age. For shortening time to market, conventionally, a platform based design is adopted in designing system hardware depending on application domains of products. Such platform-based design further incorporates with one of a variety of IP (intellectual property) designs to achieve the required functions of a system. The interface between the system core and the IP is very important to successfully integrate the IP designs into the system in the above implementation.

With reference to FIG. 1, a prior approach of integrating a new IP into a system is illustrated. The first issue is how to deal with the interface circuit compatibility between the IP and OCB (on-chip bus) specifications. Widely used buses are AMBA of ARM, IBM core connect, open source Wishbone, etc. Typically for either processor core or IP, a bus wrapper is required for meeting the required bus transaction timing if the specification of IP is not compatible with the OCB specification of pre-defined platform. Moreover, interfaces within IP is different depending on applications.

The second issue is that the communication between the processor core and IP cores is achieved by protocols of three levels, namely, the lowest bus transaction protocol, the intermediate data communication protocol, and the highest device driver. The intermediate data communication protocol is no longer related to the OCB specifications after being packaged by the bus wrapper. The intermediate data communication protocol may be implemented as single read/write, buffered FIFO (first-in-first-out) read/write, streaming data transfer, DMA (direct memory access) data transfer, shared memory communication, or the like. Some protocols are closely related with hardware resources of the platform such as DMA or FIFO.

Finally, for verifying the cooperative software, it is required to write drivers based on the requirement of RTOS (real-time operating system) specifications. Due to this face, these jobs would entail the developers' learning lots of complex expertise comprise processor core specifications, OS (operating system) driver architecture, hardware control programs, interrupt, and driver development environment. Unfortunately, such tasks are great burden to a designer, and these routines are not the key know-how in a platform based design.

In view of the above, it is understood that for designing an IP for a pre-defined hardware/software platform, a designer has to not only concentrate on the implementation of IP algorithm developed by himself/herself but also be familiar with bus protocols, OS drivers thereof, and interrupts prior to finishing the system. This is cumbersome. Therefore, it is desirable to provide a novel automated integration method of hardware/software interface for SIP development in order to mitigate and/or obviate the aforementioned problems.

### SUMMARY OF THE INVENTION

An object of the present invention is to provide an automated generation method of hardware/software interface for SIP development. The present invention is advantageous for being able to meet the needs of interface circuit, help driver registration, develop applications, and allow a user to just concentrate on the implementation of hardware and software algorithm (exclusive know-how of designer) developed by himself/herself after accomplishing the interface prototype development.

To achieve the above and other objects, the present invention provides an automated generation method of hardware/software interface for SIP development. The various templates for many kinds of application domain are offered and a picked template is established for enabling a user to quickly generate a system architecture. The steps comprise realizing hardware interface wherein generating a circuit as an interface between IP core and CPU; auto-generating a hardware access program wherein a driver is provided for a model of the interface template so that a user is able to run the driver to verify the correctness of a designed IP; designing the drivers that meet the requirements of an specific OS; and a management module. Further, hardware testing module and software timing measurement module are accompanied generated with respect to the above circuit and driver so that a user is able to evaluate system functions and performance after performing the above steps in establishing a system prototype.

Other objects, advantages, and novel features of the present invention will become more apparent from the detailed description when taken in conjunction with the accompanying drawings.

### BRIEF DESCRIPTION OF THE DRAWINGS

FIG. 1 is a block diagram of the conventional data communication between a SIP and CPU;

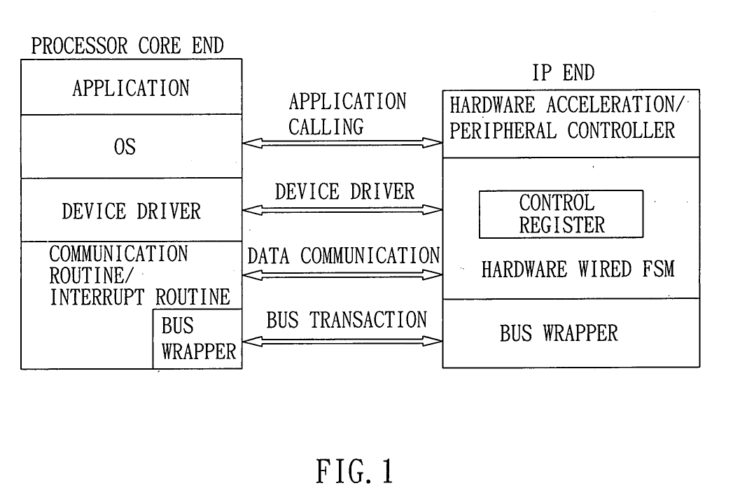

FIG. 2 is a flow chart illustrating the automated generation method of hardware/software interface for SIP development according to the present invention;

FIG. 3 is a flow chart illustrating a process of establishing an interface according to the present invention;

FIG. 4 is a flow chart illustrating a process of designing hardware access program according to the present invention; and

FIG. 5 is a flow chart illustrating a process of designing driver according to the present invention.

### DETAILED DESCRIPTION OF THE PREFERRED EMBODIMENT

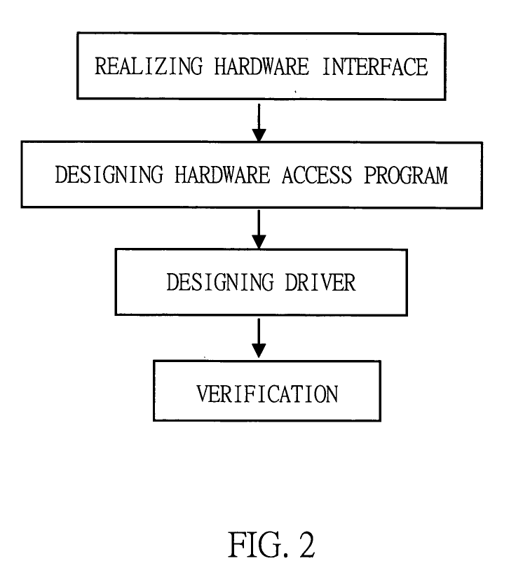

With reference to FIG. 2, there is illustrated an automated generation method of hardware/software interface for SIP development in accordance with a preferred embodiment of the present invention. The process comprises the steps of realizing hardware interface, designing hardware access program, designing driver, and verification. Each step will be described in detail below.

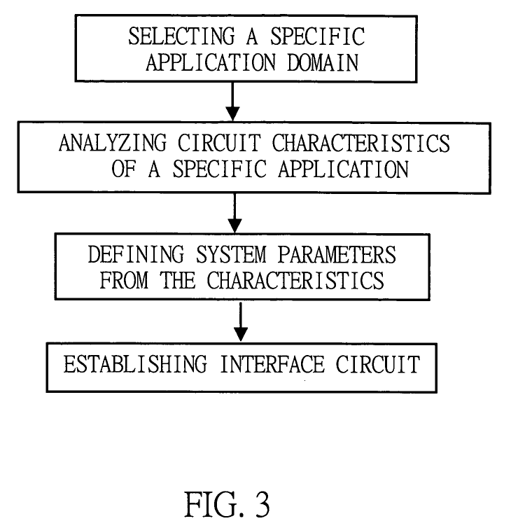

Picking a suitable template for user's application domains and than instant zing it are the main ideas of this automated generation method. The template realization is adapted to establish an interface template for enabling a user to quickly generate architecture of the whole system and thus provide a corresponding environment for hardware and software design. The design of interface template depends on the application domains. With reference to FIG. 3, there is shown a flow chart illustrating a process of hardware interface realization according to the present invention. The process comprises the steps of selecting a specific application domain in which template design is required to meet the requirements of a specific application since as stated above and then designer should input the relative parameters of the picked template; analyzing circuit characteristics requirement from the parameters of user input, including control/data registers information, synchronous/asynchronous transmission, state control, interrupt commands, and DMA control etc; defining system parameters from the characteristics, so that a computer program can reconfigure the template model for enabling the template to dynamically adjust for meeting the user input parameters and requirements of different applications; and establishing interface circuit wherein generating the bus interconnecting, bus wrapper and an interface circuit that is compatible to user input parameters described above.

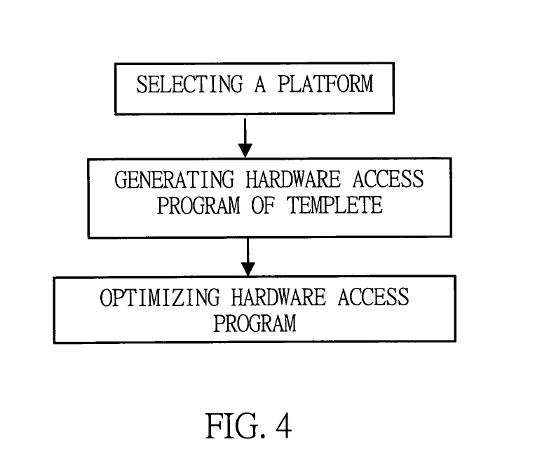

The above hardware access program step is adapted to provide a driver for the interface template model so that a user is able to run this low level driver to verify the correctness of IP. With reference to FIG. 4, there is shown a flow chart illustrating a process of designing hardware access program according to the present invention. The process comprises the steps of selecting a platform in which options of hardware architecture can affect the design of interface template, different platforms correspond to different usages, and driver design is affected by the hardware architecture so that a user has to select a platform to be developed; generating the hardware access program of template based on architecture of a platform to be developed, wherein register inputted by user and attributes of each field of the register are also analyzed based on various templates, than a hardware access program referring to the analyzing report is automatically created, and a user is thus able to control the IP by directly involving these access programs; and optimizing hardware access program with respect to a pre-defined platform.

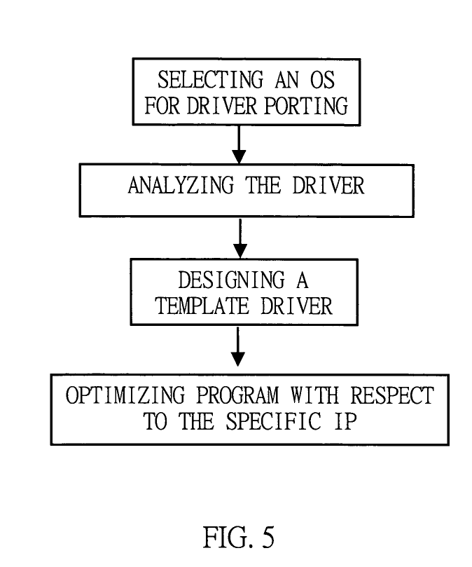

After the hardware access program has been designed, an outcome can be applied to one of a variety of OSs. Hence, the driver design step is adapted to create a driver complying with the driver architecture of OS. With reference to FIG. 5, there is shown a flow chart illustrating a process of designing driver according to the present invention. The process comprises the steps of selecting an OS for driver porting, since the driver architecture depends on the select OS; analyzing the driver in which a driver of the OS is analyzed with I/O (input/output), interrupt, and memory management associated with user input interface template being taken into consideration; designing a template driver in which a template driver is written based on the driver architecture of the OS, a driver, an ISR (interrupt service routine) prototype, and an AP (application) framework for the select OS are created automatically after obtaining the above user specified OS/hardware parameters, and a user can write a self-defined ISR and AP and than test performance of the system by directly involving the created drivers; and optimizing program with respect to the specific IP in which hardware access program is optimized with respect to the characteristics of the specific IP.

The verification step is adapted to verify the system performance by hardware/software timing measurement module that is the by-product of the generated process as described above. It not only can determine whether codes created by the interface module are correct or not but also can test the system performance as a reference for user to modify hardware and/or software.

In view of the foregoing, it is known that the present invention contemplates a template concept so that it is possible of meeting the needs of interface circuit, helping driver registration, stipulating rules for writing applications, and allowing a user to concentrate on the implementation of hardware and software algorithm developed by himself/herself after finishing the hardware/software interface development.

Although the present invention has been explained in relation to its preferred embodiment, it is to be understood that many other possible modifications and variations can be made without departing from the spirit and scope of the present invention as hereinafter claimed.

1. An automated generation method of hardware/software interface for SIP development, comprising the steps of:
realizing an interface circuit wherein an hardware is dynamically established for connecting IP core and CPU;
designing a hardware access program wherein a driver is provided for the interface template so that a user is able to involve the driver to verify the correctness of a designed IP;
designing a driver for creating a driver complying with a driver of an OS; and
accompanied testing module so as to determine the correctness of codes created from the automated generation method.

2. The method as claimed in claim 1, wherein the hardware interface realization step comprises the sub-steps of:
selecting a predetermined application domain of IP cores and the developing platform;
analyzing circuit characteristics requirement of the hardware interface of the IP;
defining system parameters from the characteristics; and
establishing interface circuit.

3. The method as claimed in claim 1, wherein the hardware access program design step comprises the sub-steps of:
selecting a platform;
generating the hardware access program of the template based on the architecture of the platform to be developed by analyzing the parameters form the user input; and
optimizing the hardware access program with respect to the characteristics of hardware.

4. The method as claimed in claim 1, wherein the driver design step comprises the sub-steps of:
selecting an OS for driver porting;
analyzing the driver of the OS;
generating a driver of the template based on the driver of the OS and the parameters form the user input; and
optimizing the driver with respect to the characteristics of the predetermined hardware.
